(19) United States
(12) Patent Application Publication
(10) Pub. No.: US 2024/0295043 A1
(43) Pub. Date: Sep. 5, 2024

(54) ADVANCED PURIFICATION CELL FOR ALUMINUM SCRAP RECYCLING

(71) Applicant: ALCOA USA CORP., Pittsburgh, PA (US)

(72) Inventor: Xinghua Liu, Murrysville, PA (US)

(21) Appl. No.: 18/663,576

(22) Filed: May 14, 2024

Related U.S. Application Data
(63) Continuation of application No. PCT/US2022/049783, filed on Nov. 14, 2022.
(60) Provisional application No. 63/335,984, filed on Apr. 28, 2022.
(60) Provisional application No. 63/279,447, filed on Nov. 15, 2021.

(51) Int. Cl. C25C 3/08; C25C 3/14

(52) U.S. Cl. CPC C25C 3/08; C25C 3/14

(57) ABSTRACT

The present disclosure includes a method for purifying aluminum. The method includes producing purified aluminum from an aluminum feedstock in an aluminum purification cell and flowing the purified aluminum from a cell chamber of the aluminum purification cell to a purified metal reservoir via an overflow passage, wherein the purified metal reservoir is located internal to the aluminum purification cell. In some embodiments, a feeding reservoir is located internal to the aluminum purification cell and can be accessed via a feeding port located in a refractory top cover of the cell chamber. In some embodiments, the method includes removing the purified aluminum from the purified metal reservoir via a tapping port located in a refractory top cover of the cell chamber. In some embodiments, concomitant with the removing step, the method includes restricting or preventing oxidation of the purified aluminum.

### CROSS REFERENCE TO RELATED APPLICATIONS

This application is a continuation of International Patent Application No. PCT/US2022/049783, entitled “Advanced Purification Cell for Aluminum Scrap Recycling,” filed Nov. 14, 2022, which claims the benefit of U.S. Provisional Patent Application No. 63/279,447, entitled “Advanced Purification Cell For Aluminum Scrap Recycling,” filed Nov. 15, 2021 and the benefit of U.S. Provisional Patent Application No. 63/335,984, entitled “Advanced Purification Cell For Aluminum Scrap Recycling,” filed Apr. 28, 2022. Each of the above-identified patent applications is hereby incorporated by reference in its entirety.

### BACKGROUND

Aluminum has been traditionally made from alumina (Al₂O₃) that has been originated from bauxite ore. The conversion of alumina (Al₂O₃) to aluminum has been typically carried out via a smelting method that entails dissolving the alumina (Al₂O₃) in cryolite, a molten solvent, and then passing an electric current through the mixture, causing carbon from a carbon anode to attach to the oxygen component in the dissolved alumina (Al₂O₃), yielding aluminum and carbon dioxide as a by-product. Various efforts have been made to purify aluminum including the “Hoopes process” (see U.S. Pat. No. 1,534,315) as well as those methods described in commonly owned international patent application WO 2016/130823.

### SUMMARY OF THE DISCLOSURE

Broadly, the present disclosure relates to methods and systems for producing purified aluminum via an aluminum purification cell that may include one or more reservoirs internal to the cell. For instance, in one embodiment, a cell may include one or both of (i) a feeding reservoir internal to the cell and (ii) a purified metal reservoir internal to the cell. Locating one or more reservoirs internal to the cell may restrict/prevent oxidation because, in at least partly, the cell may be hermetically sealed. In some embodiments, fluids into and out of the cell may be provided through ports to maintain the hermetical seal. For instance, in one embodiment, a feeding port can provide access to the feeding reservoir and/or a tapping port can provide access to the purified metal reservoir. In some instances, inert gas may also be provided to the cell to further prevent/restrict oxidation of the aluminum metal. With one or more reservoirs located internal to the cell, the inert gas can provide an inert atmosphere to the cell including the one or more reservoirs. In some embodiments, when producing purified aluminum, the one or more reservoirs can reduce cell disturbances due to (i) feeding aluminum feedstock to the cell and/or (ii) tapping the purified aluminum from the purified metal reservoir. The present disclosure can also reduce heat loss and improve energy consumption during operation of the aluminum purification cell. The methods disclosed herein may, for instance, be more cost-effective at producing purified aluminum products.

In one aspect, the present disclosure includes a method for purifying aluminum, including: producing purified aluminum from an aluminum feedstock in an aluminum purification cell, wherein the purified aluminum has a density less than an electrolyte of the aluminum purification cell, wherein the electrolyte has a density less than a molten metal pad of the aluminum purification cell and flowing the purified aluminum from a cell chamber of the aluminum purification cell to a purified metal reservoir via an overflow passage, wherein the purified metal reservoir is located internal to the aluminum purification cell.

In some embodiments, the producing step includes feeding the aluminum feedstock into the aluminum purification cell, wherein the aluminum feedstock includes aluminum metal (e.g., aluminum scrap), and wherein the aluminum purification cell includes the molten metal pad and the electrolyte.

In some embodiments, feeding the aluminum feedstock step includes flowing the aluminum feedstock into the molten metal pad via a feeding reservoir located internal to the aluminum purification cell. In some embodiments, the aluminum feedstock is an aluminum alloy scrap. In some embodiments, the aluminum alloy scrap includes scrap of a 1xxx-series aluminum alloy, a 2xxx-series aluminum alloy, a 3xxx-series aluminum alloy, a 4xxx-series aluminum alloy, a 5xxx-series aluminum alloy, a 6xxx-series aluminum alloy, a 7xxx-series aluminum alloy, a 8xxx-series aluminum alloy, or any combinations thereof. In some embodiments, the aluminum alloy scrap includes new aluminum scrap and/or old aluminum scrap.

Aluminum scrap can be described as new scrap or old scrap. New aluminum scrap is aluminum scrap from fabrication processes, and old aluminum scrap is aluminum scrap from post-consumer use. New aluminum scrap is generated during the manufacturing of aluminum semi-fabricated and final products. Old aluminum scrap is scrap from products collected after disposal by consumers. Old aluminum scrap can be more contaminated than new aluminum scrap. Some examples of old aluminum scrap include, but are limited to, end-of-life vehicles, demolished buildings, demolished construction material, discarded packaging material, home and office appliances, and machinery equipment.

The collection and sorting of aluminum scrap, e.g., old aluminum scrap, can be a complex scheme involving millions of households, local and regional authorities, small and medium collectors, and metal merchants. Waste and environmental policies can also have strong influences on the effectiveness of collection schemes.

Aluminum scrap sometimes needs to be separated, further sorted, and pre-treated before the metal can be recovered in melting furnaces. Separation of aluminum scrap at this stage can be done by various mechanical operations, such as magnetic, gravity, eddy current, or color sensor. Further separation of different aluminum alloys can also be achieved through x-ray, x-ray fluorescence (XRF) spectrometry, and/or laser induced breakdown spectroscopy (LIBS) methods. For example, wrought alloys and casting alloys can be separated before the mechanical processes.

In some embodiments, the aluminum purification cell includes the cell chamber at least partially defined by refractory sidewalls, a refractory top cover, and a cell bottom, and wherein the cell bottom is located proximal a base. In some embodiments, the present disclosure includes providing access to the purified metal reservoir via a feeding port penetrating a refractory top cover of the cell chamber. In some embodiments, the present disclosure includes providing an inert gas to the cell chamber via an inert gas inlet formed in a refractory top cover of the cell chamber, thereby providing an inert atmosphere to the cell chamber. In some embodiments, the present disclosure includes maintaining the inert atmosphere of the cell chamber of the aluminum purification cell while feeding the aluminum feedstock into a feeding reservoir, producing the purified aluminum, and removing the purified aluminum from the aluminum purification cell via a tapping port.

In some embodiments, the present disclosure includes removing the purified aluminum from the purified metal reservoir via a tapping port located in a refractory top cover of the cell chamber. In some embodiments, the present disclosure includes that concomitant with the removing step, restricting or preventing oxidation of the purified aluminum. In some embodiments, the present disclosure includes that a feeding port of the feeding reservoir and the tapping port of the purified metal reservoir define at least partly a hermetic seal of the cell chamber.

In some embodiments, the present disclosure includes that at least one anode overlaps at least one cathode thereby defining an anode-cathode overlap wherein a distal end of the at least one cathode is proximal a middle portion of the at least one anode, and wherein a distal end of the at least one anode is proximal a middle portion of the at least one cathode. In some embodiments, the producing step includes passing electrical current into at least one anode through the electrolyte and into at least one cathode, (i) wherein the at least one anode and the at least one cathode are partially disposed in the electrolyte, and (ii) wherein the at least one anode is partially disposed in the molten metal pad. In some embodiments, the producing step includes producing aluminum ions in the electrolyte and reducing at least some of the aluminum ions at or near at least one cathode of the aluminum purification cell. In some embodiments, the producing step includes producing aluminum ions from the at least one anode, moving at least some of the aluminum ions into the electrolyte, and reducing the at least some of the aluminum ions at or near at least one cathode of the aluminum purification cell.

In another aspect, the present disclosure includes an aluminum purification cell, including: a cell chamber including a cell bottom, refractory sidewalls, and a refractory top cover; at least one anode extending upward from the cell bottom; a cathode connector located proximal the refractory top cover; at least one cathode extending downward from the cathode connector; and an overflow passage extending from the cell chamber to a purified metal reservoir located internal to the aluminum purification cell.

In some embodiments, the aluminum purification cell further includes a tapping port 200 and a feeding port located in the refractory top cover of the cell chamber. In some embodiments, the feeding port and the tapping port define at least partly a hermetic seal of the cell chamber. In some embodiments, the aluminum purification cell further includes a feeding reservoir located internal to the aluminum purification cell. In some embodiments, the feeding reservoir directs an aluminum feedstock directly into a molten metal pad of the cell chamber. In some embodiments, the aluminum purification cell further includes: an inert gas inlet formed in the refractory top cover and configured to provide an inert atmosphere to the cell chamber. In some embodiments, a distal end 92 of the at least one anode 90 and a distal end 152 of the at least one cathode 150 partially overlap.

While the present disclosure is generally directed to purifying aluminum, the apparatus, system, and methods described herein are applicable to purifying other metals (e.g., magnesium).

### BRIEF DESCRIPTION OF THE DRAWINGS

FIG. 1 is a schematic cut-away side view of an embodiment of an aluminum purification cell for purifying aluminum, in accordance with some embodiments.

FIG. 2 is a schematic cut-away side view of an embodiment of an aluminum purification cell for purifying aluminum, in accordance with some embodiments.

FIG. 3 illustrates one embodiment of a method for purifying aluminum metal, such as aluminum scrap, in an aluminum purification cell.

### DETAILED DESCRIPTION

The present disclosure will be further explained with reference to the attached figures, wherein like structures are referred to by like numerals throughout the several views. The figures constitute a part of this specification and include illustrative embodiments of the present disclosure and illustrate various objects and features thereof. Further, the figures are not necessarily to scale, some features may be exaggerated to show details of components. In addition, any measurements, specifications, and the like shown in the figures are intended to be illustrative, and not restrictive. Therefore, specific structural and functional details disclosed herein are not to be interpreted as limiting, but merely as a representative basis for teaching one skilled in the art to variously employ the present disclosure.

Among those benefits and improvements that have been disclosed, other objects and advantages of the present disclosure will become apparent from the following description taken in conjunction with the accompanying figures. Detailed embodiments of the present disclosure are disclosed herein; however, it is to be understood that the disclosed embodiments are merely illustrative of the present disclosure that may be embodied in various forms. In addition, each of the examples given in connection with the various embodiments of the present disclosure which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the present disclosure may be readily combined, without departing from the scope or spirit of the present disclosure.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

As used herein, “aluminum feedstock” means material having at least 50 wt. % aluminum.

As used herein, “purified aluminum” means material having at least 99.5 wt. % aluminum.

As used herein, “molten metal pad” means a reservoir of molten material located below an electrolyte, wherein the molten material comprises aluminum.

As used herein, “aluminum-wettable” means having a contact angle with molten aluminum of not greater than 90 degrees.

As used herein, “electrolyte” means a medium in which the flow of electrical current is carried out by the movement of ions/ionic species. In one embodiment, an electrolyte may comprise molten salt.

As used herein, “energy efficiency” means the amount of energy (in kilowatt hours) consumed by an aluminum purification cell per kilogram of purified aluminum produced by the aluminum purification cell. Thus, energy efficiency may be expressed in kilowatt hours/kilogram of aluminum produced (kWh/kg).

As used herein, “anode-cathode overlap” (ACO) means the vertical distance from the distal end of an anode (e.g., elongate vertical anode) to the distal end of a respective cathode (e.g., elongate vertical cathode).

As used herein, “anode-to-cathode distance” (ACD) means the horizontal distance separating an anode (e.g., elongate vertical anode) from a respective cathode (e.g., elongate vertical cathode).

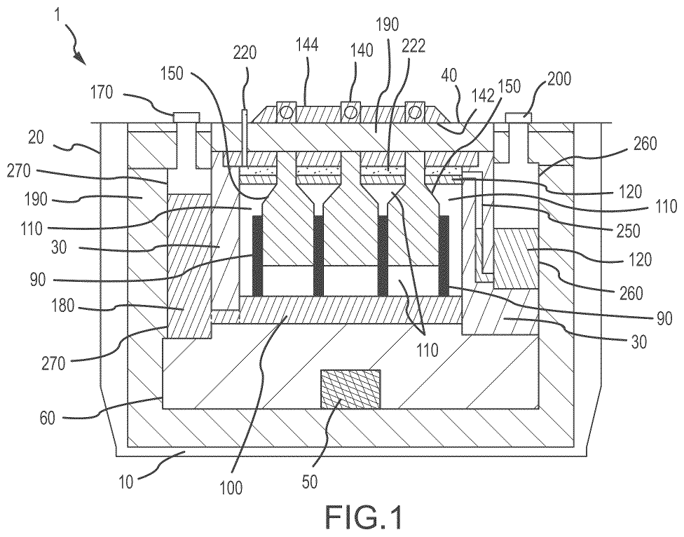

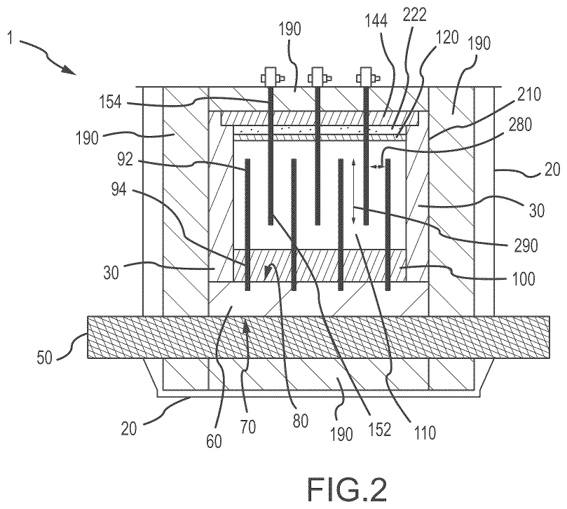

FIG. 1 and FIG. 2 are a schematic cut-away side view of an embodiment of an aluminum purification cell 1 for purifying aluminum, in accordance with some embodiments. The aluminum purification cell 1 includes a cell chamber 210 with a cell bottom 60, refractory sidewalls 30, and a refractory top cover 40, at least one anode 90 extending upward from the cell bottom 60, a cathode connector 140 located proximal the refractory top cover 40, at least one cathode 150 extending downward from the cathode connector 140, and an overflow passage 250 extending from the cell chamber 210 to a purified metal reservoir 260 located internal to the aluminum purification cell 1. One example of the aluminum purification cell 1 can be found in commonly owned U.S. Pat. No. 10,407,786, entitled Systems and Methods for Purifying Aluminum, and filed on Feb. 11, 2016, which is incorporated by reference in its entirety.

The cell chamber 210 is at least partially defined by refractory sidewalls 30, refractory top cover 40, and cell bottom 60. The cell bottom 60 is located proximal a base 10. In some embodiments, the cell chamber 210 includes a tapping port 200 and a feeding port 170 where both are located in the refractory top cover 40 of the cell chamber 210. The feeding port 170 and the tapping port 200 define at least partly a hermetic seal of the cell chamber 210. The feeding port 170 connects to feeding reservoir 270. The feeding reservoir 270 is located internal to the aluminum purification cell 1. The tapping port 200 connects to the purified metal reservoir 260. The feeding reservoir 270 is located internal to the aluminum purification cell 1. The purified metal reservoir 260 and feeding reservoir 270 are located within the hermetically sealed environment of the aluminum purification cell 1.

The aluminum purification cell 1 further includes an inert gas inlet 220 formed in the refractory top cover 40 and configured to provide an inert atmosphere to the hermetically sealed cell chamber 210. In addition to the inert gas inlet 220, the feeding reservoir 270 and the purified metal reservoir 260 can each have an inert gas inlet to provide an inert atmosphere for the hermetically sealed environment. By providing inert gas 222 in the cell chamber 210, oxygen is further prevented or restricted from entering the cell chamber 210.

The design of the aluminum purification cell 1 enables the cell chamber 210 to be sealed from air and prevent or restrict oxidation of a top metal of a purified aluminum 120 in the aluminum purification cell 1. The feeding port 170 allows for scrap (e.g., scrap containing aluminum) to be fed and mixed with anodic metal. The feeding port 170 can reduce disturbances to the molten metal pad 100 of the cell chamber 210 during feeding of the scrap to the cell chamber 210. Similarly, the tapping port 200 eliminates disturbances during metal tapping. The design of the aluminum purification cell 1, including the internally located purified metal reservoir 260 and feeding reservoir 270, enables feeding the aluminum feedstock 180 to the feeding reservoir 270, purifying the aluminum feedstock 180 to the purified aluminum 120 in the cell chamber 210, and removing the purified aluminum 120 from the purified metal reservoir 260 while maintaining a hermetic seal of the cell chamber 210.

In some embodiments, the feeding reservoir 270 is carbon-based. In some embodiments, the feeding reservoir 270 is anodic and not electrically isolated. The feeding reservoir 270 directs the aluminum feedstock 180 directly into the molten metal pad 100 of the cell chamber 210. In some embodiments, the molten metal pad 100 includes at least 50 wt. % aluminum metal. In some embodiments, the molten metal pad 100 includes at least one alloy including one or more of Al, Si, at least 0.5 wt. % Cu, Fe, Sb, Gd, Cd, Sn, Pb and impurities.

The purified metal reservoir 260 is located internal to the aluminum purification cell 1. In some embodiments, the purified metal reservoir 260 is substantially surrounded by a refractory material (e.g., the refractory sidewalls 30). In some embodiments, the purified metal reservoir 260 is partially surrounded by a refractory material. Access to the purified metal reservoir 260 is via tapping port 200 penetrating refractory top cover 40 of the cell chamber 210.

Similar to the tapping port 200, the feeding port 170 penetrates refractory top cover 40, thereby providing access to the feeding reservoir 270. The feeding reservoir 270 provides access to the lower portion of the cell chamber 210, including the molten metal pad 100.

In some embodiments, the refractory top cover 40 can be integral or have distinct parts. For example, the refractory top cover 40 can have a distinct and separate cover for the feeding reservoir 270 and the feeding port 170. Likewise, the refractory top cover 40 can have a distinct and separate cover for the purified metal reservoir 260 and the tapping port 200.

The cell bottom 60 includes an upper surface 80 and a lower surface 70. In some embodiments, the cell bottom 60 is flat. In some embodiments, the cell bottom 60 is downwardly sloped towards the feeding reservoir 270. In some embodiments, the slope of the cell bottom 60 has an angle of less than 10 degrees. In some embodiments, the slope of the cell bottom 60 has an angle of from 3 to 5 degrees.

The aluminum purification cell 1 includes a cathode connector 140 proximal a refractory top cover 40. The cathode connector 140 includes an upper connection rod 130 configured to connect to an external power source. The cathode connector 140 includes a lower surface 142 and an upper surface 144. Opposite the cathode connector 140, the aluminum purification cell 1 includes an anode connector 50 in electrical communication with the cell bottom 60. The anode connector 50 is configured to connect to an external power source.

The at least one anode 90 and the at least one cathode 150 are electrodes. In some embodiments, some of the electrodes are made from the same material and some are made from a different material than one another. In some embodiments, all the electrodes are made from a different material than one another. In some embodiments, all the electrodes are made from the same material. In some embodiments, some of the electrodes are made of carbonaceous material and some of the electrodes are made of a non-carbonaceous material.

The electrodes (i.e., the at least one anode 90 and the at least one cathode 150) are configured from an aluminum-wettable material. In some embodiments, the electrodes include one or more of TiB₂, ZrB₂, HfB₂, SrB₂, carbonaceous material (e.g., graphite), non-carbonaceous material, or combinations thereof. In some embodiments, the electrodes are made from a non-carbonaceous material. In some embodiments, the electrodes are made from a cermet or a ceramic. In some embodiments, the electrodes are ceramic. In some embodiments, the electrodes consist essentially of TiB₂. In some embodiments, the electrodes are made of multiple layers.

The at least one anode 90 is disposed on a cell bottom 60 of the aluminum purification cell 1. The at least one anode 90 includes a proximal end 94 connected to an upper surface 80 of the cell bottom 60. The at least one anode 90 includes a distal end 92 extending upward toward the refractory top cover 40 of the aluminum purification cell 1. The at least one anode 90 includes a middle portion therebetween the distal end 92 and the proximal end 94. In some embodiments, the at least one anode 90 is a vertical anode.

The at least one cathode 150 includes a proximal end 154 connected to the cathode connector 140 and a distal end 152 extending downward toward the base 10. The at least one cathode 150 includes a middle portion between the proximal end 154 and the distal end 152. In some embodiments, the at least one cathode 150 is a vertical cathode. The at least one anode 90 may be interleaved with the at least one cathode 150.

In some embodiments, the at least one anode 90 overlaps the at least one cathode 150 thereby defining an anode-cathode overlap (ACO) 290. The distal end 92 of the at least one anode 90 and a distal end 152 of the at least one cathode 150 partially overlap. In some embodiments, the distal end 152 of the at least one cathode 150 is proximal a middle portion of the at least one anode 90, and a distal end 92 of the at least one anode 90 is proximal a middle portion of the at least one cathode 150. In some embodiments, the anode-cathode overlap (ACO) 290 is 0 to 50 inches. In some embodiments, the anode-cathode overlap 290 is 1 to 50 inches. In some embodiments, the anode-cathode overlap 290 is 5 to 50 inches. In some embodiments, the anode-cathode overlap 290 is 10 to 50 inches. In some embodiments, the anode-cathode overlap 290 is 20 to 50 inches. In some embodiments, the anode-cathode overlap 290 is 25 to 50 inches. In some embodiments, the anode-cathode overlap 290 is at least some overlap up to 12 inches of overlap. In some embodiments, the anode-cathode overlap 290 is at least 2 inches of overlap to 10 inches of overlap. In some embodiments, the anode-cathode overlap 290 is at least 3 inches of overlap to 8 inches of overlap. In some embodiments, the anode-cathode overlap 290 is at least 3 inches of overlap to 6 inches of overlap.

The lateral spacing distance between the at least one anode 90 and the at least one cathode 150 can be specified as anode-to-cathode distance (ACD) 280. In some embodiments, the anode-to-cathode distance 280 may be ⅛ inch to 3 inches. In some embodiments, the anode-to-cathode distance 280 may be ⅛ inch to 2 inches. In some embodiments, the anode-to-cathode distance 280 may be ⅛ inch to 1 inch. In some embodiments, the anode-to-cathode distance 280 may be ⅛ inch to ¼ inch. In some embodiments, the anode-to-cathode distance 280 may be ¼ inch to ½ inch. In some embodiments, the anode-to-cathode distance 280 may be ⅛ inch to ¾ inch. In some embodiments, the anode-to-cathode distance 280 may be ⅛ inch to 1 inch. In some embodiments, the anode-to-cathode distance 280 may be ⅛ inch to ½ inch.

In some embodiments, the aluminum purification cell 1 includes an outer shell 20. The outer shell 20 may include steel or other suitable materials. In some embodiments, the outer shell 20 may include a shell floor located beneath the base 10. In some embodiments, the outer shell 20 may include shell sidewalls spaced apart from and surrounding the refractory sidewalls 30.

In some embodiments, the aluminum purification cell 1 may include a cell lining 190 to provide thermal insulation to the cell chamber 210. The cell lining 190 may be located between the refractory sidewalls 30 and the outer shell 20 and between the base 10 and the cell bottom 60. In some embodiments, the cell lining 190 may encapsulate substantially all of the cell chamber 210 or only a portion of the cell chamber 210. The cell lining 190 may facilitate high electrical efficiency of the aluminum purification cell 1.

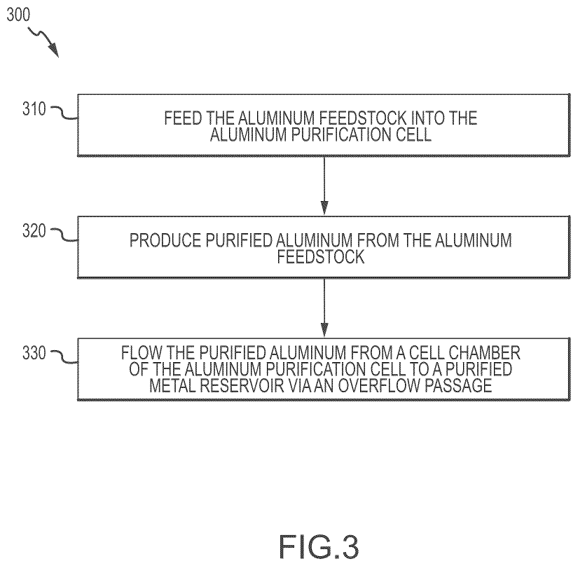

FIG. 3 illustrates one embodiment of a method 300 for purifying aluminum metal, such as aluminum scrap, in an aluminum purification cell. The method 300 for purifying aluminum includes feeding 310 the aluminum feedstock 180 into the aluminum purification cell 1, passing electrical current through the at least one anode 90, directing aluminum metal of the molten metal pad 100 towards the electrolyte 110, producing at least some ions in the electrolyte 110, and producing 320 the purified aluminum 120 from the aluminum feedstock 180. The method 300 further includes flowing 330 the purified aluminum 120 from the cell chamber 210 of the aluminum purification cell 1 to the purified metal reservoir 260 via the overflow passage 250.

In some embodiments, the cell chamber 210 contains a molten metal pad 100, the purified aluminum 120, and the electrolyte 110. The molten metal pad 100 is in contact with the cell bottom 60. The electrolyte 110 separates the purified aluminum 120 from the molten metal pad 100. The anode 90 extends upward from the cell bottom 60, through the molten metal pad 100 and terminates in the electrolyte 110. The cathode 150 extends downward from the cathode connector 140 and terminates in the electrolyte 110 such that the cathode 150 overlaps the anode 90 within the electrolyte 110. Thus, the cathode 150 is separated from the anode 90 by electrolyte 110.

In the illustrated embodiment, the purified aluminum 120 has a density less than an electrolyte 110 of the aluminum purification cell 1. The electrolyte 110 has a density less than the molten metal pad 100 of the aluminum purification cell 1. The electrolyte 110 separates the top layer of purified aluminum 120 from the molten metal pad 100. In this regard, the composition of the electrolyte 110 may be selected such that the electrolyte 110 has a lower density than the molten metal pad 100 and higher density than the purified aluminum 120. In some embodiments, the electrolyte 110 includes molten salt. In some embodiments, the electrolyte 110 includes at least one of fluorides and/or chlorides. In some embodiments, the electrolyte 110 contains at least one of fluorides and/or chlorides of Na, K, Al, Ba, Ca, Ce, La, Cs, Rb, or combinations thereof, among others.

In some embodiments, the molten metal pad 100 includes at least 5 wt. % aluminum metal, or at least 10 wt. % aluminum metal, or at least 15 wt. % aluminum metal, or at least 20 wt. % aluminum metal, or at least 25 wt. % aluminum metal, or at least 30 wt. % aluminum metal, or at least 35 wt. % aluminum metal, or at least 40 wt. % aluminum metal, or at least 45 wt. % aluminum metal, or at least 50 wt. % aluminum metal, or at least 55 wt. % aluminum metal, or at least 60 wt. % aluminum metal, or at least 65 wt. % aluminum metal, or at least 70 wt. % aluminum metal, or at least 75 wt. % aluminum metal, or at least 80 wt. % aluminum metal, or at least 85 wt. % aluminum metal, or at least 90 wt. % aluminum metal, or at least 95 wt. % aluminum metal.

In some embodiments, the molten metal pad 100 includes at least one alloy including one or more of Al, Si, Cu, Fe, Sb, Gd, Cd, Sn, Pb and impurities. In some embodiments, the composition of the wettable material on the anode 90 in the aluminum purification cell 1 is the same as or substantially similar to the molten metal pad 100. In some embodiments, the composition of the wettable material is metal. In some embodiments, the metal includes aluminum or at least aluminum and magnesium. In some embodiments, the metal includes at least 5 wt. % aluminum, or at least 10 wt. % aluminum, or at least 15 wt. % aluminum, or at least 20 wt. % aluminum, or at least 25 wt. % aluminum, or at least 30 wt. % aluminum, or at least 35 wt. % aluminum, or at least 40 wt. % aluminum, or at least 45 wt. % aluminum, or at least 50 wt. % aluminum, or at least 55 wt. % aluminum, or at least 60 wt. % aluminum, or at least 65 wt. % aluminum, or at least 70 wt. % aluminum, or at least 75 wt. % aluminum, or at least 80 wt. % aluminum, or at least 85 wt. % aluminum, or at least 90 wt. % aluminum, or at least 95 wt. % aluminum. In some embodiments, the metal is selected from the group consisting of an aluminum alloy, metallic aluminum, and combinations thereof.

The method 300 includes producing 320 purified aluminum 120 from the aluminum feedstock 180 by passing electrical current into the at least one anode 90 through the electrolyte 110 and into the at least one cathode 150. In some embodiments, the passing electrical current includes passing direct current from the at least one anode 90 to the at least one cathode 150 through electrolyte 110. When producing 320 the purified aluminum 120, the at least one anode 90 and the at least one cathode 150 can be partially disposed in the electrolyte 110 and the at least one anode 90 can be partially disposed in the molten metal pad 100. Directing aluminum metal of the molten metal pad 100 towards the electrolyte 110 can include flowing the aluminum metal towards the electrolyte 110 and supplying an electric current to the at least one anode 90.

The aluminum purification cell 1 includes the molten metal pad 100 and the electrolyte 110. In some embodiments, feeding 310 the aluminum feedstock 180 includes flowing the aluminum feedstock 180 into the molten metal pad 100 via the feeding reservoir 270 located internal to the aluminum purification cell 1.

As discussed herein, feeding 310 the aluminum feedstock 180 may be through an aluminum purification cell 1. In some embodiments, the feeding 310 step includes feeding the aluminum feedstock 180 continuously during operation of the aluminum purification cell 1. In some embodiments, the feeding 310 step includes periodically adding the aluminum feedstock 180 into the aluminum purification cell 1. In some embodiments, the feeding 310 step includes metering aluminum feedstock 180 into the aluminum purification cell 1 at a first feed rate. The first feed rate may remain constant or may vary, including stopping and starting of the feeding 310 of the aluminum feedstock 180 to the aluminum purification cell 1. In some embodiments, the feeding 310 step includes adding the aluminum feedstock 180 periodically to the aluminum purification cell 1.

In some embodiments, the aluminum feedstock 180 includes aluminum metal. In some embodiments, the aluminum feedstock 180 includes at least one other metal than aluminum metal. In some embodiments, the aluminum feedstock 180 includes a transition metal. In some embodiments, the aluminum feedstock 180 includes at least 50 wt. % aluminum metal, or at least 55 wt. % aluminum metal, or at least 60 wt. % aluminum metal, or at least 65 wt. % aluminum metal, or at least 70 wt. % aluminum metal, or at least 75 wt. % aluminum metal, or at least 80 wt. % aluminum metal, or at least 85 wt. % aluminum metal, or at least 90 wt. % aluminum metal, or at least 95 wt. % aluminum metal.

In some embodiments, the aluminum feedstock 180 includes impurities. In some embodiments, the impurities of the aluminum feedstock 180 can include Cr, Cu, Fe, Mg, Mn, Ni, Si, Ti, and Zn. In some embodiments, the aluminum feedstock 180 can have aluminum with up to 2 wt. % Mg, along with other impurities. In some embodiments, the aluminum feedstock 180 includes impurities of from 0.5 wt. % to 50.0 wt. % of the aluminum feedstock 180. In some embodiments, the aluminum feedstock 180 includes impurities. In some embodiments, the aluminum feedstock 180 includes impurities of from 0.5 wt. % to 50.0 wt. % of the aluminum feedstock 180. In some embodiments, the aluminum feedstock 180 includes impurities of from 5.0 wt. % to 50.0 wt. % of the aluminum feedstock 180. In some embodiments, the aluminum feedstock 180 includes impurities of from 10.0 wt. % to 50.0 wt. % of the aluminum feedstock 180. In some embodiments, the aluminum feedstock 180 includes impurities of from 15.0 wt. % to 50.0 wt. % of the aluminum feedstock 180. In some embodiments, the aluminum feedstock 180 includes impurities of from 20.0 wt. % to 50.0 wt. % of the aluminum feedstock 180. In some embodiments, the aluminum feedstock 180 includes impurities of from 25.0 wt. % to 50.0 wt. % of the aluminum feedstock 180. In some embodiments, the aluminum feedstock 180 includes impurities of from 30.0 wt. % to 50.0 wt. % of the aluminum feedstock 180. In some embodiments, the aluminum feedstock 180 includes impurities of from 35.0 wt. % to 50.0 wt. % of the aluminum feedstock 180. In some embodiments, the aluminum feedstock 180 includes impurities of from 40.0 wt. % to 50.0 wt. % of the aluminum feedstock 180. In some embodiments, the aluminum feedstock 180 includes impurities of from 45.0 wt. % to 50.0 wt. % of the aluminum feedstock 180. In some embodiments, the aluminum feedstock 180 includes impurities of from 0.5 wt. % to 45.0 wt. % of the aluminum feedstock 180. In some embodiments, the aluminum feedstock 180 includes impurities of from 0.5 wt. % to 40.0 wt. % of the aluminum feedstock 180. In some embodiments, the aluminum feedstock 180 includes impurities of from 0.5 wt. % to 35.0 wt. % of the aluminum feedstock 180. In some embodiments, the aluminum feedstock 180 includes impurities of from 0.5 wt. % to 30.0 wt. % of the aluminum feedstock 180. In some embodiments, the aluminum feedstock 180 includes impurities of from 0.5 wt. % to 25.0 wt. % of the aluminum feedstock 180. In some embodiments, the aluminum feedstock 180 includes impurities of from 0.5 wt. % to 20.0 wt. % of the aluminum feedstock 180. In some embodiments, the aluminum feedstock 180 includes impurities of from 0.5 wt. % to 15.0 wt. % of the aluminum feedstock 180. In some embodiments, the aluminum feedstock 180 includes impurities of from 0.5 wt. % to 10.0 wt. % of the aluminum feedstock 180. In some embodiments, the aluminum feedstock 180 includes impurities of from 0.5 wt. % to 5.0 wt. % of the aluminum feedstock 180.

In some embodiments, additives (e.g., copper) are added to the aluminum feedstock 180 to increase density and keep the metal of the aluminum feedstock 180 on the bottom of the aluminum purification cell 1 at the molten metal pad 100. In some examples, the aluminum feedstock 180 includes at least 5 wt. % copper, at least 10 wt. % copper, at least 15 wt. % copper, at least 20 wt. % copper, at least 25 wt. % copper, at least 30 wt. % copper, at least 35 wt. % copper, at least 40 wt. % copper, at least 45 wt. % copper, or at least 50 wt. % copper. Accordingly, the molten metal pad 100 may include a relatively high amount of copper. In some embodiments, the molten metal pad 100 includes at least 5 wt. % copper, at least 10 wt. % copper, at least 15 wt. % copper, at least 20 wt. % copper, at least 25 wt. % copper, at least 30 wt. % copper, at least 35 wt. % copper, at least 40 wt. % copper, at least 45 wt. % copper, at least 50 wt. % copper, or more.

In some embodiments, the aluminum feedstock 180 is an aluminum alloy scrap. In some embodiments, the aluminum alloy scrap includes at least one of a 1xxx-series aluminum alloy, a 2xxx-series aluminum alloy, a 3xxx-series aluminum alloy, a 4xxx-series aluminum alloy, a 5xxx-series aluminum alloy, a 6xxx-series aluminum alloy, a 7xxx-series aluminum alloy, a 8xxx-series aluminum alloy, or any combinations thereof.

In some embodiments, the producing 320 step includes producing aluminum ions in the electrolyte 110 and reducing at least some of the aluminum ions at or near at least one cathode 150 of the aluminum purification cell 1. In some embodiments, the producing 320 step includes moving aluminum ions through the electrolyte 110 toward the at least one cathode 150.

The purified aluminum 120 product above the electrolyte 110 defines a top layer. In some embodiments, the purified aluminum 120 product includes an aluminum purity of at least 99.5 wt. % up to 99.999 wt. % aluminum. In some embodiments, the purified aluminum 120 product includes an aluminum purity of at least 99.8 wt. % up to 99.999 wt. % aluminum. In some embodiments, the purified aluminum 120 product includes an aluminum purity of at least 99.9 wt. % up to 99.999 wt. % aluminum. In some embodiments, the purified aluminum 120 product includes an aluminum purity of at least 99.98 wt. % up to 99.999 wt. % aluminum.

In some embodiments, the purified aluminum 120 product may be produced via the aluminum purification cell 1 at an energy efficiency of 1 to 15 kWh/kg of purified aluminum. In some embodiments, the purified aluminum 120 product may be produced via the aluminum purification cell 1 at an energy efficiency of 1 to 10 kWh/kg of purified aluminum. In some embodiments, the purified aluminum 120 product may be produced via the aluminum purification cell 1 at an energy efficiency of 1 to 8 kWh/kg of purified aluminum. In some embodiments, the purified aluminum 120 product may be produced via the aluminum purification cell 1 at an energy efficiency of 1 to 6 kWh/kg of purified aluminum. In some embodiments, the purified aluminum 120 product may be produced via the aluminum purification cell 1 at an energy efficiency of 1 to 4 kWh/kg of purified aluminum. In some embodiments, the purified aluminum 120 product may be produced via the aluminum purification cell 1 at an energy efficiency of 5 to 15 kWh/kg of purified aluminum. In some embodiments, the purified aluminum 120 product may be produced via the aluminum purification cell 1 at an energy efficiency of 10 to 15 kWh/kg of purified aluminum. In some embodiments, the purified aluminum 120 product may be produced via the aluminum purification cell 1 at an energy efficiency of 12 to 15 kWh/kg of purified aluminum.

As stated above, the method 300 further includes flowing 330 the purified aluminum 120 from a cell chamber 210 of the aluminum purification cell 1 to the purified metal reservoir 260 via an overflow passage 250. Stated another way, the overflow passage 250 extends from the cell chamber 210 to the purified metal reservoir 260 located internal to the aluminum purification cell 1. The overflow passage 250 provides access from an upper portion of the cell chamber 210 to the purified metal reservoir 260. When the purified aluminum 120 reaches the level of the overflow passage 250, the purified aluminum 120 flows from the upper portion of the cell chamber 210 to the purified metal reservoir 260. The purified aluminum 120 can then be tapped from the purified metal reservoir 260 via the tapping port 200.

In some embodiments, the present disclosure includes providing an inert gas 222 to the cell chamber 210 via an inert gas inlet 220 formed in a refractory top cover 40 of the cell chamber 210, thereby providing an inert atmosphere to the cell chamber 210. In some embodiments, the present disclosure includes maintaining the inert atmosphere of the cell chamber 210 of the aluminum purification cell 1 while feeding the aluminum feedstock 180 into a feeding reservoir 270, producing the purified aluminum 120, and removing the purified aluminum 120 from the aluminum purification cell 1 via tapping port 200.

The purified aluminum 120 can be removed from the purified metal reservoir 260 via a tapping port 200 located in a refractory top cover 40 of the cell chamber 210. In some embodiments, concomitant with removing the purified aluminum 120, the method includes restricting, reducing, or preventing air oxidation of the purified aluminum 120 in the cell chamber 210 when removing the purified aluminum 120 from the purified metal reservoir 260. In some embodiments, removing the purified aluminum 120 from the purified metal reservoir 260 includes removing the purified aluminum 120 via the tapping port 200 located in a refractory top cover 40 of the cell chamber 210.

In some embodiments, the present disclosure includes removing at least some of the top layer of the purified aluminum 120 from the purified metal reservoir 260 via the tapping port 200. In some embodiments, the purified aluminum 120 may be removed continuously during operation of the aluminum purification cell 1. In some embodiments, a first removal rate may be controlled, for example, based at least in part on a second removal rate. In some embodiments, the purified aluminum 120 may be removed periodically during operation of the aluminum purification cell 1. In some embodiments, the removing step is completed with equipment configured to remove the purified aluminum 120 product without contaminating the product (e.g., alumina, graphite, and/or TiB₂ tapping equipment).

The present disclosure accomplishes restricting, reducing, or preventing air oxidation of the purified aluminum 120 in the cell chamber 210 by preventing air entering the cell chamber 210. The design of the aluminum purification cell 1 enables the cell chamber 210 to be sealed from air and prevent oxidation of the top metal of the purified aluminum 120 in the aluminum purification cell 1.

While a number of embodiments of the present disclosure have been described, it is understood that these embodiments are illustrative only, and not restrictive, and that many modifications may become apparent to those of ordinary skill in the art. The various steps may be carried out in any desired order (and any desired steps may be added and/or any desired steps may be eliminated). For example, the features and characteristics of the aluminum purification cell 1 can be used together or alone with any other system and/or product. For example, in some embodiments, only one of the purified metal reservoir 260 and feeding reservoir 270 may be integrated with and internal to the aluminum purification cell 1. The features and characteristics of the aluminum purification cell 1 as described in any of the embodiments can be used in any other embodiment described herein. The exemplary embodiments of the aluminum purification cell 1 are not meant to be exhaustive. The features and characteristics of the present disclosure can be combined in any manner.

What is claimed is:

1. A method for purifying aluminum, comprising:
(a) producing purified aluminum from an aluminum feedstock in an aluminum purification cell, wherein the purified aluminum has a density less than an electrolyte of the aluminum purification cell, wherein the electrolyte has a density less than a molten metal pad of the aluminum purification cell; and
(b) flowing the purified aluminum from a cell chamber of the aluminum purification cell to a purified metal reservoir via an overflow passage, wherein the purified metal reservoir is located internal to the aluminum purification cell.

2. The method of claim 1, further comprising, prior to the producing step (a):
feeding the aluminum feedstock into the aluminum purification cell,
wherein the aluminum feedstock comprises aluminum metal, and
wherein the aluminum purification cell comprises the molten metal pad and the electrolyte.

3. The method of claim 2, wherein the feeding the aluminum feedstock step comprises:
flowing the aluminum feedstock into the molten metal pad via a feeding reservoir located internal to the aluminum purification cell.

4. The method of claim 1, wherein the aluminum feedstock comprises an aluminum alloy scrap.

5. The method of claim 4, wherein the aluminum alloy scrap comprises a 1xxx-series aluminum alloy, a 2xxx-series aluminum alloy, a 3xxx-series aluminum alloy, a 4xxx-series aluminum alloy, a 5xxx-series aluminum alloy, a 6xxx-series aluminum alloy, a 7xxx-series aluminum alloy, a 8xxx-series aluminum alloy, or any combinations thereof.

6. The method of claim 4, wherein the aluminum alloy scrap comprises new aluminum scrap and/or old aluminum scrap.

7. The method of claim 1, wherein the aluminum purification cell further comprises the cell chamber at least partially defined by refractory sidewalls, a refractory top cover, and a cell bottom, and wherein the cell bottom is located proximal a base.

8. The method of claim 1, further comprising:
providing access to the purified metal reservoir via a feeding port penetrating a refractory top cover of the cell chamber.

9. The method of claim 1, further comprising:
providing an inert gas to the cell chamber via an inert gas inlet formed in a refractory top cover of the cell chamber, thereby providing an inert atmosphere to the cell chamber.

10. The method of claim 9, further comprising:
maintaining the inert atmosphere of the cell chamber of the aluminum purification cell while feeding the aluminum feedstock into a feeding reservoir, producing the purified aluminum, and removing the purified aluminum from the aluminum purification cell via a tapping port.

11. An aluminum purification cell, comprising:
(a) a cell chamber comprising a cell bottom, refractory sidewalls, and a refractory top cover;
(b) at least one anode extending upward from the cell bottom;
(c) a cathode connector located proximal the refractory top cover;
(d) at least one cathode extending downward from the cathode connector; and
(e) an overflow passage extending from the cell chamber to a purified metal reservoir located internal to the aluminum purification cell.

12. The aluminum purification cell of claim 11, further comprising:
a tapping port and a feeding port located in the refractory top cover of the cell chamber.

13. The aluminum purification cell of claim 12, wherein the feeding port and the tapping port define at least partly a hermetic seal of the cell chamber.

14. The aluminum purification cell of claim 11, further comprising:
a feeding reservoir located internal to the aluminum purification cell.

15. The aluminum purification cell of claim 14, wherein the feeding reservoir directs an aluminum feedstock directly into a molten metal pad of the cell chamber.

16. The aluminum purification cell of claim 11, wherein the purified metal reservoir comprises purified aluminum metal.
